(19) United States
(12) Patent Application Publication
(10) Pub. No.: US 2014/0185233 A1
(43) Pub. Date: Jul. 3, 2014

(54) HINGE ASSEMBLY FOR ELECTRONIC DEVICE

(71) Applicants: MARK MACDONALD, Beaverton, OR (US); SHAWN S. MCEUEN, Portland, OR (US)

(72) Inventors: MARK MACDONALD, Beaverton, OR (US); SHAWN S. MCEUEN, Portland, OR (US)

(21) Appl. No.: 13/729,230

(22) Filed: Dec. 28, 2012

(51) Int. Cl. G06F 1/16

(52) U.S. Cl. CPC G06F 1/1681
USPC 361/679.55; 16/366; 16/337; 16/354; 312/223.2

(57) ABSTRACT

In one embodiment an electronic device comprises at least one electronic component and a housing comprising a first section to be rotatable about a first hinge pin extending along a first axis extending proximate a first edge, a second section to be rotatable about a second hinge pin extending along a second axis substantially parallel to the first axis, and at least one connecting arm to be coupled to the first hinge pin and the second hinge pin. Other embodiments may be described.

### BACKGROUND

The subject matter described herein relates generally to the field of electronic devices and more particularly to a hinge assembly for one or more electronic devices.

Some electronic devices utilize a “clamshell” housing. By way of example, many laptop computers and mobile electronic devices utilize a clamshell housing in which a keyboard is disposed on a first section and a display is disposed on a second section coupled to the first section by a hinge. Alternatively, a “clamshell” can consist of displays, one on a first section that can also be utilized as a touch keyboard and one display on a second section coupled to the first section by a hinge.

The advent of tablet computers has driven a market for laptop devices that are convertible between a traditional notebook and a tablet configuration. Accordingly hinge assemblies which enable a clamshell housing to convert between configurations may find utility.

### BRIEF DESCRIPTION OF THE DRAWINGS

The detailed description is described with reference to the accompanying figures.

FIG. 1 is a schematic illustration of an exemplary electronic device which may include a hinge assembly in accordance with some embodiments.

FIGS. 2A-2C are schematic illustrations of a hinge assembly in accordance with some embodiments.

FIGS. 3A-3D are schematic illustrations of portions of a housing for an electronic device incorporating a hinge assembly in accordance with some embodiments.

FIGS. 4-7 are schematic illustrations of electronic devices which may be modified to include a hinge assembly in accordance with some embodiments.

### DETAILED DESCRIPTION

Described herein are exemplary hinge assemblies to enable the rotation of an electronic device which uses a clamshell housing. An electronic device such as a laptop computer in which the display section flips 360° relative to the base section to convert to a tablet configuration may utilize two hinge axes. Disclosed herein is a dual-axis hinge assembly that enables a singular, fluid motion throughout the 360° rotation and requires no mechanisms to lock/unlock the axis rotation. Rather, each axis rotates at the same pace as the other because opposing surfaces or gears of the hinge assembly maintain contact with each other, which facilitates maintaining alignment of the base section and the display section.

In the following description, numerous specific details are set forth to provide a thorough understanding of various embodiments. However, it will be understood by those skilled in the art that the various embodiments may be practiced without the specific details. In other instances, well-known methods, procedures, components, and circuits have not been illustrated or described in detail so as not to obscure the particular embodiments.

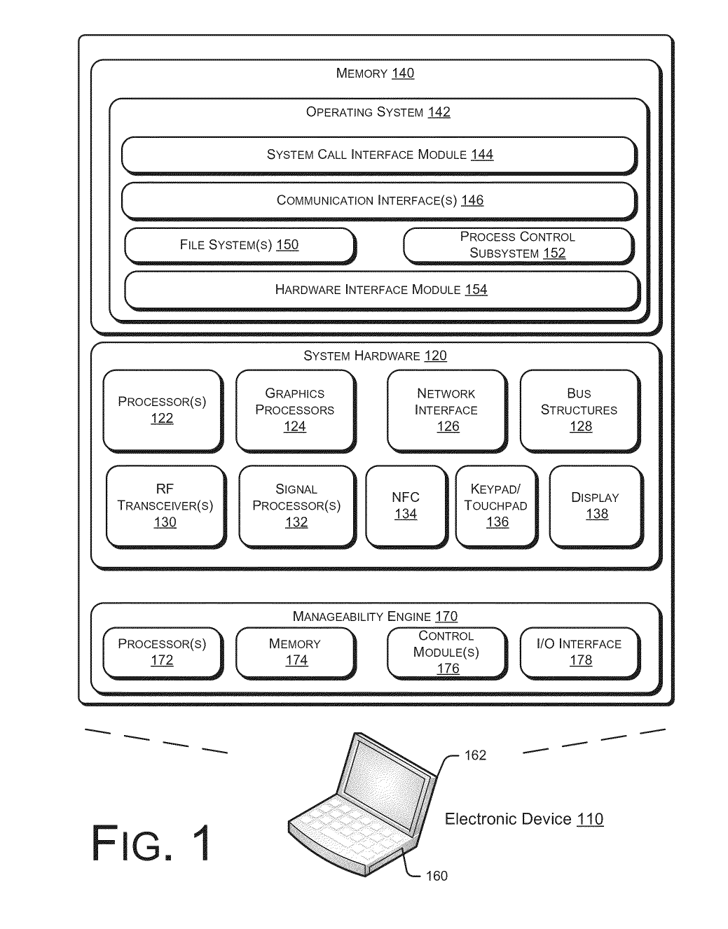

FIG. 1 is a schematic illustration of an exemplary electronic device 110 which may be adapted to include a hinge assembly in accordance with some embodiments. As illustrated in FIG. 1, electronic device 110 may be embodied as a conventional mobile device such as a laptop computer, a mobile phone, tablet computer portable computer, or personal digital assistant (PDA). The particular device configuration is not critical.

In various embodiments, electronic device 110 may include or be coupled to one or more accompanying input/output devices including a display, one or more speakers, a keyboard, one or more other I/O device(s), a mouse, a camera, or the like. Other exemplary I/O device(s) may include a touch screen, a voice-activated input device, a track ball, a geolocation device, an accelerometer/gyroscope, biometric feature input devices, and any other device that allows the electronic device 110 to receive input from a user.

The electronic device 110 includes system hardware 120 and memory 140, which may be implemented as random access memory and/or read-only memory. A file store may be communicatively coupled to computing device 110. The file store may be internal to computing device 110 such as, e.g., eMMC, SSD, one or more hard drives, or other types of storage devices. File store 180 may also be external to computer 110 such as, e.g., one or more external hard drives, network attached storage, or a separate storage network.

System hardware 120 may include one or more processors 122, graphics processors 124, network interfaces 126, and bus structures 128. In one embodiment, processor 122 may be embodied as an Intel® Atom™ processors, Intel® Atom™ based System-on-a-Chip (SOC) or Intel® Core2 Duo® or i3/i5/i7 series processor available from Intel Corporation, Santa Clara, Calif., USA. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

Graphics processor(s) 124 may function as adjunct processor that manages graphics and/or video operations. Graphics processor(s) 124 may be integrated onto the motherboard of electronic device 110 or may be coupled via an expansion slot on the motherboard or may be located on the same die or same package as the Processing Unit.

In one embodiment, network interface 126 could be a wired interface such as an Ethernet interface (see, e.g., Institute of Electrical and Electronics Engineers/IEEE 802.3-2002) or a wireless interface such as an IEEE 802.11a, b or g-compliant interface (see, e.g., IEEE Standard for IT-Telecommunications and information exchange between systems LAN/MAN-Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Bus structures 128 connect various components of system hardware 128. In one embodiment, bus structures 128 may be one or more of several types of bus structure(s) including a memory bus, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI), a High Speed Synchronous Serial Interface (HSI), a Serial Low-power Inter-chip Media Bus (SLIMbus®), or the like.

Electronic device 110 may include an RF transceiver 130 to transceive RF signals, a Near Field Communication (NFC) radio 134, and a signal processing module 132 to process signals received by RF transceiver 130. RF transceiver may implement a local wireless connection via a protocol such as, e.g., Bluetooth or 802.11x. IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a WCDMA, LTE, general packet radio service (GPRS) interface (see, e.g., Guidelines on GPRS Handset Requirements, Global System for Mobile Communications/GSM Association, Ver. 3.0.1, December 2002).

Electronic device 110 may further include one or more input/output interfaces such as, e.g., a keypad 136 and a display 138. In some embodiments electronic device 110 may not have a keypad and use the touch panel for input.

Memory 140 may include an operating system 142 for managing operations of computing device 110. In one embodiment, operating system 142 includes a hardware interface module 154 that provides an interface to system hardware 120. In addition, operating system 140 may include a file system 150 that manages files used in the operation of computing device 110 and a process control subsystem 152 that manages processes executing on computing device 110.

Operating system 142 may include (or manage) one or more communication interfaces 146 that may operate in conjunction with system hardware 120 to transceive data packets and/or data streams from a remote source. Operating system 142 may further include a system call interface module 144 that provides an interface between the operating system 142 and one or more application modules resident in memory 130. Operating system 142 may be embodied as a UNIX operating system or any derivative thereof (e.g., Linux, Android, etc.) or as a Windows® brand operating system, or other operating systems.

In some embodiments an electronic device may include a manageability engine 170, which may comprise one or more controllers that are separate from the primary execution environment. The separation may be physical in the sense that the manageability engine may be implemented in controllers which are physically separate from the main processors. Alternatively, the trusted execution environment may logical in the sense that the manageability engine may be hosted on same chip or chipset that hosts the main processors.

By way of example, in some embodiments the manageability engine 170 may be implemented as an independent integrated circuit located on the motherboard of the electronic device 110, e.g., as a dedicated processor block on the same SOC die. In other embodiments the trusted execution engine may be implemented on a portion of the processor(s) 122 that is segregated from the rest of the processor(s) using hardware enforced mechanisms

In the embodiment depicted in FIG. 1 the manageability engine 170 comprises a processor 172, a memory module 174, a control module 176, and an I/O interface 178. In some embodiments the memory module 174 may comprise a persistent flash memory module and the various functional modules may be implemented as logic instructions encoded in the persistent memory module, e.g., firmware or software. The I/O module 178 may comprise a serial I/O module or a parallel I/O module. Because the manageability engine 170 is separate from the main processor(s) 122 and operating system 142, the manageabilty engine 170 may be made secure, i.e., inaccessible to hackers who typically mount software attacks from the host processor 122.

In some embodiments the electronic device 100 may comprise a hinge assembly which enables the first section 160 and the second section 162 to be rotatable between a first position in which the second section 162 is parallel with a first side of the first section 160 and a second position in which the second section is fully rotated about the first section, such that the second section 162 is parallel with a second side of the first section 160. In embodiments in which the second section includes a single display the first position may correspond to the electronic device being in a closed configuration and the second position may correspond to the electronic device being in an open configuration which may be suitable for use as a tablet device.

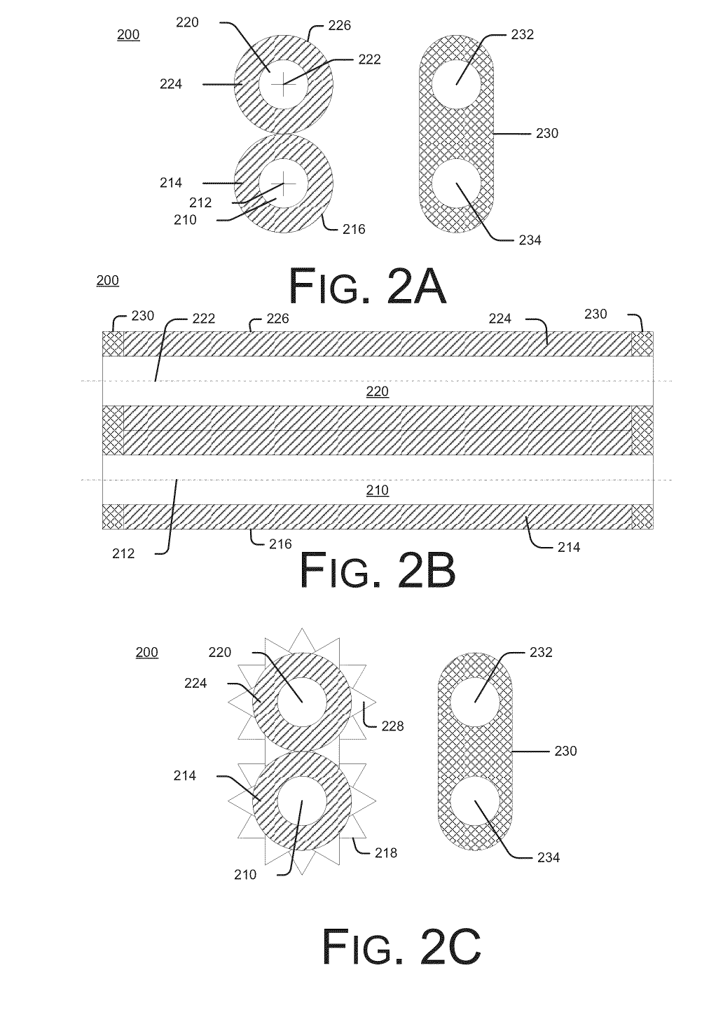

Embodiments of a locking hinge assembly will be described with reference to FIGS. 2A-2C. FIG. 2A is a schematic, side view illustration and FIG. 2B is a schematic end view illustration of an exemplary hinge assembly 200 which may be used in a clamshell housing of an electronic device, in accordance with some embodiments. Referring to FIGS. 2A-2B, in some embodiments a hinge assembly 200 comprises a first hinge pin 210 extending along a first axis 212 and a first body 214 rotatable about the first hinge pin 210 and having a first rolling surface 216 which extends radially about the first axis 212. Hinge assembly 200 further comprises a second hinge pin 220 extending along a second axis 222 substantially parallel to the first axis 210 and a second body 224 rotatable about the second hinge pin 220 and having a second rolling surface 226 which extends radially about the second axis 222. Hinge assembly 200 further comprises at least one connecting arm 230 to be coupled to the first hinge pin 210 and the second hinge pin 220. In some embodiments the connecting arm 230 is dimensioned such that the first rolling surface 216 maintains contact with the second rolling surface 226 when the bodies 214, 224, are rotated about their respective hinge pins 210, 220.

In various embodiments the hinge pins 210, 220 may be formed from a suitably rigid material, e.g., a metal, plastic, or composite material. As illustrated in FIG. 2A, the hinge pins 210, 220 may be substantially circular a cross section taken perpendicular to the axes 212, 222. As illustrated in FIG. 2B, in some embodiments the hinge pins 210, 220 may extend through the entire length a shaft in each of the respective bodies 214, 224. One skilled in the art will recognize that other embodiments two or more hinge pins extending through a portion of the shaft in each of the respective bodies 214, 224.

The respective bodies 214, 224 may be formed from a suitably rigid material, e.g., a metal, plastic, or composite material. As illustrated in FIGS. 2A-2B, the first rolling surface 216 is disposed at a first distance from the first axis 212 the second rolling surface 226 is disposed at a second distance from the second axis 222. In some embodiments the first distance and the second distance may be different, while in other embodiments the first distance and the second distance may be the same.

The connecting arm 230 may be formed form a suitably rigid material, e.g., a metal, plastic, or composite material. As illustrated in FIGS. 2A-2B the connecting arm 230 may comprise apertures 232, 234 which are positioned to correspond to the positions of the hinge pins 210, 220. The apertures 232, 234 may be dimensioned to receive the respective hinge pins 210, 220, as illustrated in FIG. 2B. Further, the apertures 232, 234 may be positioned such that the connecting arm holds the first rolling surface 216 in contact with the second rolling surface 226 when the bodies 214, 224 are rotated about their respective hinge pins 210, 220.

In various embodiments at least one of the first rolling surface 216 or the second rolling surface 226 may comprise a pattern or a coating or material that creates or induces friction between the rotating surfaces. By way of example a friction inducing pattern may be embossed on the surface(s) 216, 226. Alternatively, a friction inducing coating may be applied to the surface(s) 216, 226, or the surfaces 216, 226 may be coated with a friction inducing material.

As illustrated in FIG. 2C, in some embodiments a gear assembly 218, 228 may comprise one or more gear assemblies mounted on a portion of the respective rolling surfaces 216, 226. In some embodiments the gear assembly may regulate the rotation of the respective rolling surfaces 216, 226.

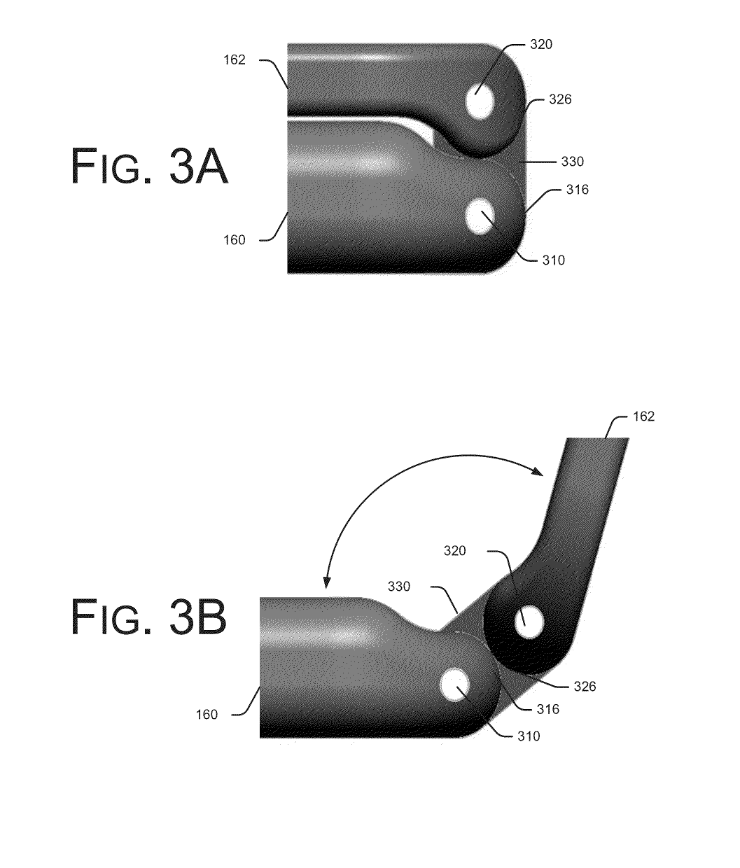

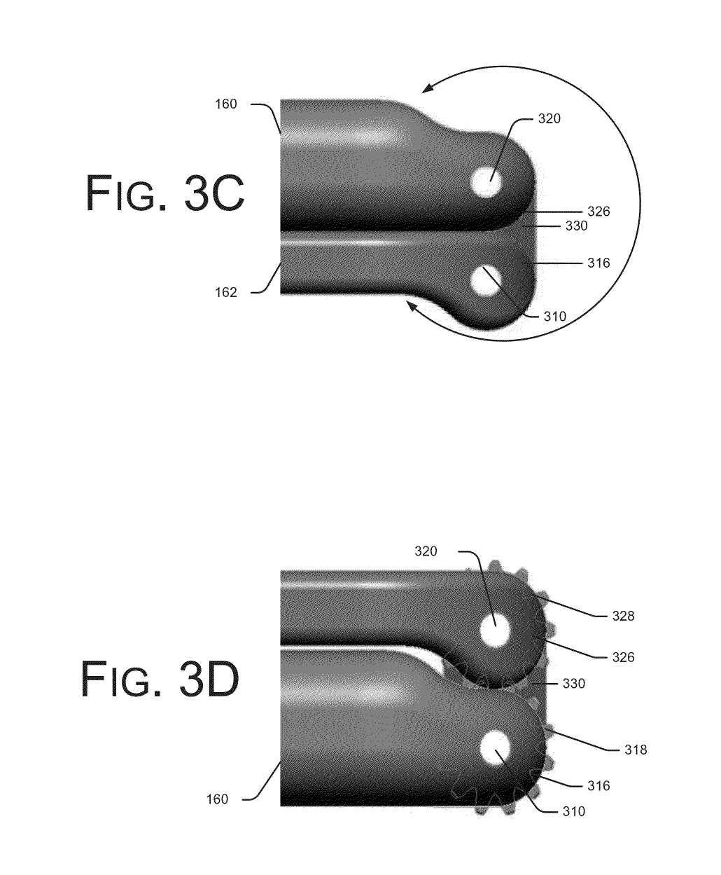

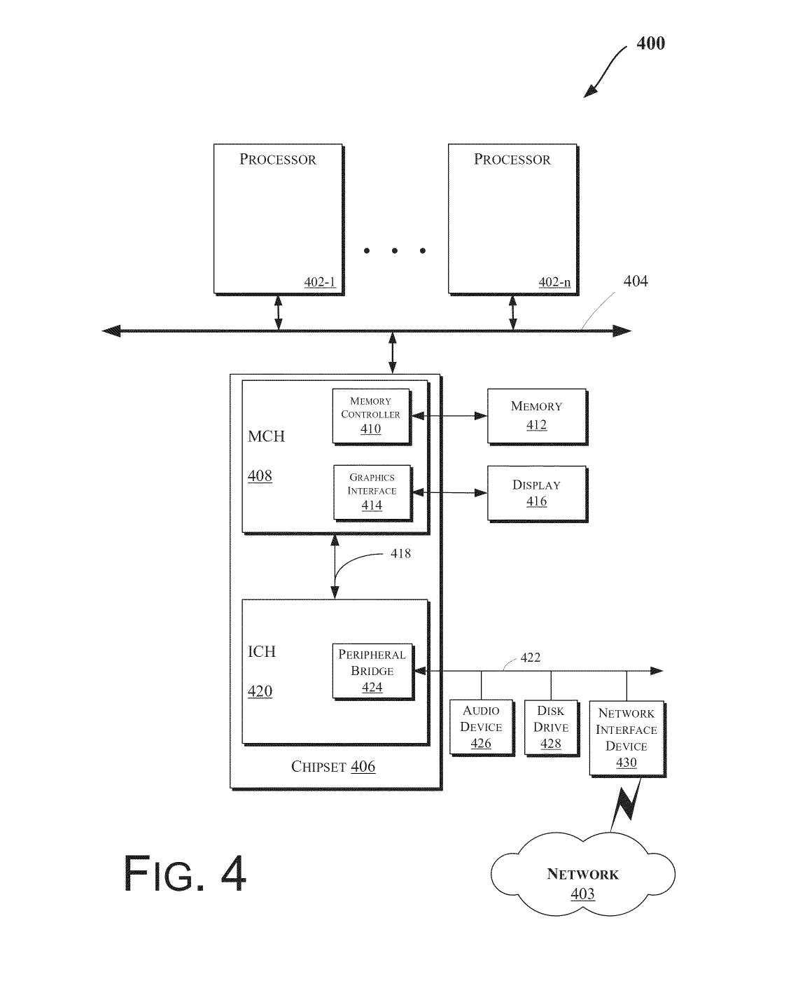

In some embodiments a hinge assembly as depicted in FIGS. 2A-2C may be incorporated into a housing for an electronic device, such as an electronic device 110 depicted in FIG. 1. FIGS. 3A-3C are schematic illustrations of portions of a housing for an electronic device incorporating a hinge assembly in accordance with some embodiments. Referring to FIGS. 3A-3C, in some embodiments a housing for an electronic device 110 comprises a first section 160 and a second section 162. As described above, the first section 160 may correspond to a base of a laptop personal computer and may comprise a keyboard and one or more additional input output devices. Further, the first section may comprise internal components of a computer system, as described above with reference to FIG. 1. Second section 162 may comprise a display and one or more additional input/output devices, e.g., a touch screen, a microphone, a camera, or the like.

In some embodiments a housing for an electronic device may comprise a hinge assembly as depicted in FIGS. 2A-2C such that the first section 160 and the second section are fully rotatable through a 360 degree range of motion. Stated otherwise, the second section 162 of the electronic device is rotatable through a 360 degree rotation about the first section 160 between a first position, as depicted in FIG. 3A, in which the second section 162 is disposed on a first side of the first section 160, and a second position, as depicted in FIG. 3C, in which the second section 162 is disposed on a second side of the first section 160. In the first position the electronic the electronic device 110 may be closed. In the second position the electronic device may be opened in a configuration which is appropriate for use as a tablet computing device.

Referring to FIGS. 3A-3D, in some embodiments the first section 310 may be rotatable about a first hinge pin 310 extending along a first axis proximate a rear edge of the first section 160. Similarly, the second section 162 may be rotatable about a second hinge pin 320 extending along a second axis substantially parallel to the first axis. At least one connecting arm 330 may be coupled to the first hinge pin 310 and the second hinge pin 320.

As described above, the first section 160 comprises a first rolling surface 316 extending radially about the first axis at a first distance form the first axis. Similarly, the second section 162 comprises a second rolling surface 326 that extending radially about the second axis at a second distance from the second axis. As described above with reference to FIGS. 2A-2C, the first distance and the second distance may be the same or different.

In various embodiments at least one of the first rolling surface 316 or the second rolling surface 326 may comprise a pattern or a coating or material that creates or induces friction between the rotating surfaces. By way of example a friction inducing pattern may be embossed on the surface(s) 316, 326. Alternatively, a friction inducing coating may be applied to the surface(s) 316, 326, or the surfaces 316, 326 may be coated with a friction inducing material.

As illustrated in FIG. 3D, in some embodiments a gear assembly 318, 328 may comprise one or more gear assemblies mounted on a portion of the respective rolling surfaces 316, 326. In some embodiments the gear assembly may regulate the rotation of the respective rolling surfaces 316, 326.

As illustrated in FIGS. 3A-3C, a hinge assembly in accordance with embodiments described herein enables the second section 162 of the housing for an electronic device 110 to be fully rotatable around the first section 162 from a first position in which the electronic device 110 is closed and a second position in which the electronic device 110 is configured for use as a tablet computing device. The respective rolling surfaces 316, 326 maintain contact with one another during the rotation process, in some cases providing frictional engagement between the respective surfaces 316, 326.

As described above, in some embodiments the electronic device may be embodied as a computer system. FIG. 4 illustrates a block diagram of a computing system 400 in accordance with an embodiment of the invention. The computing system 400 may include one or more central processing unit(s) (CPUs) 402 or processors that communicate via an interconnection network (or bus) 404. The processors 402 may include a general purpose processor, a network processor (that processes data communicated over a computer network 403), or other types of a processor (including a reduced instruction set computer (RISC) processor or a complex instruction set computer (CISC)). Moreover, the processors 402 may have a single or multiple core design. The processors 402 with a multiple core design may integrate different types of processor cores on the same integrated circuit (IC) die. Also, the processors 402 with a multiple core design may be implemented as symmetrical or asymmetrical multiprocessors. In an embodiment, one or more of the processors 402 may be the same or similar to the processors 102 of FIG. 1. For example, one or more of the processors 402 may include the control unit 120 discussed with reference to FIGS. 1-3. Also, the operations discussed with reference to FIGS. 1-3 may be performed by one or more components of the system 400.

A chipset 406 may also communicate with the interconnection network 404. The chipset 406 may include a memory control hub (MCH) 408. The MCH 408 may include a memory controller 410 that communicates with a memory 412 (which may be the same or similar to the memory 114 of FIG. 1). The memory 412 may store data, including sequences of instructions, that may be executed by the CPU 402, or any other device included in the computing system 400. In one embodiment of the invention, the memory 412 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 404, such as multiple CPUs and/or multiple system memories.

The MCH 408 may also include a graphics interface 414 that communicates with a display device 416. In one embodiment of the invention, the graphics interface 414 may communicate with the display device 416 via an accelerated graphics port (AGP). In an embodiment of the invention, the display 416 (such as a flat panel display) may communicate with the graphics interface 414 through, for example, a signal converter that translates a digital representation of an image stored in a storage device such as video memory or system memory into display signals that are interpreted and displayed by the display 416. The display signals produced by the display device may pass through various control devices before being interpreted by and subsequently displayed on the display 416.

A hub interface 418 may allow the MCI 408 and an input/output control hub (ICH) 420 to communicate. The ICH 420 may provide an interface to I/O device(s) that communicate with the computing system 400. The ICH 420 may communicate with a bus 422 through a peripheral bridge (or controller) 424, such as a peripheral component interconnect (PCI) bridge, a universal serial bus (USB) controller, or other types of peripheral bridges or controllers. The bridge 424 may provide a data path between the CPU 402 and peripheral devices. Other types of topologies may be utilized. Also, multiple buses may communicate with the ICH 420, e.g., through multiple bridges or controllers. Moreover, other peripherals in communication with the ICH 420 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 422 may communicate with an audio device 426, one or more disk drive(s) 428, and a network interface device 430 (which is in communication with the computer network 403). Other devices may communicate via the bus 422. Also, various components (such as the network interface device 430) may communicate with the MCH 408 in some embodiments of the invention. In addition, the processor 402 and one or more other components discussed herein may be combined to form a single chip (e.g., to provide a System on Chip (SOC)). Furthermore, the graphics accelerator 416 may be included within the MCH 408 in other embodiments of the invention.

Furthermore, the computing system 400 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 428), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

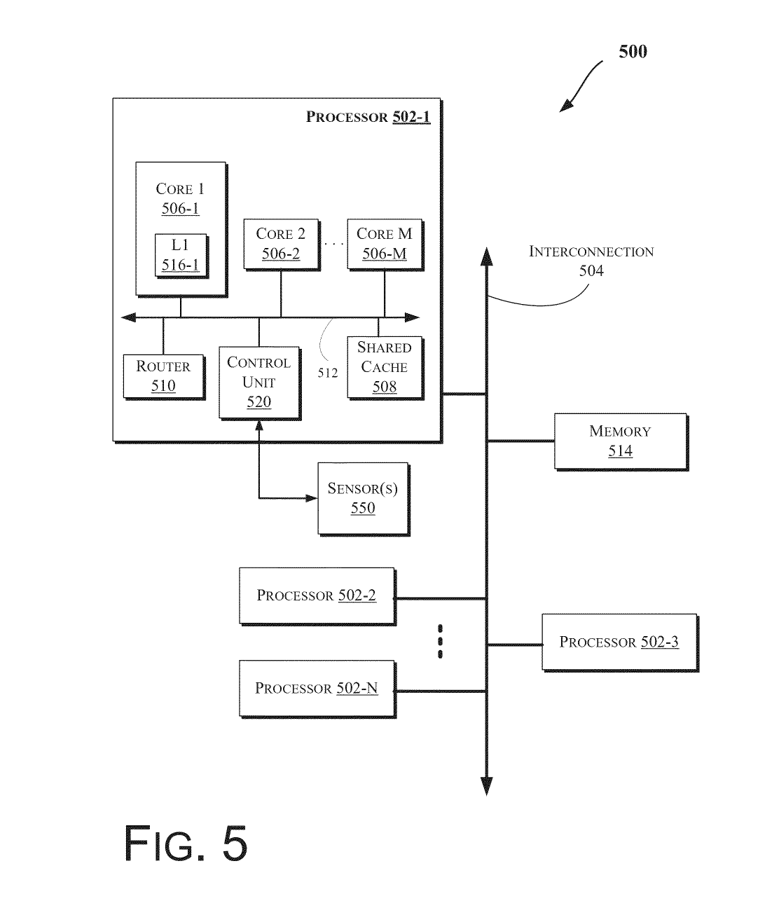

FIG. 5 illustrates a block diagram of a computing system 500, according to an embodiment of the invention. The system 500 may include one or more processors 502-1 through 502-N (generally referred to herein as “processors 502” or “processor 502”). The processors 502 may communicate via an interconnection network or bus 504. Each processor may include various components some of which are only discussed with reference to processor 502-1 for clarity. Accordingly, each of the remaining processors 502-2 through 502-N may include the same or similar components discussed with reference to the processor 502-1.

In an embodiment, the processor 502-1 may include one or more processor cores 506-1 through 506-M (referred to herein as “cores 506” or more generally as “core 506”), a shared cache 508, a router 510, and/or a processor control logic or unit 520. The processor cores 506 may be implemented on a single integrated circuit (IC) chip. Moreover, the chip may include one or more shared and/or private caches (such as cache 508), buses or interconnections (such as a bus or interconnection network 512), memory controllers (such as those discussed with reference to FIGS. 4-5), or other components.

In one embodiment, the router 510 may be used to communicate between various components of the processor 502-1 and/or system 500. Moreover, the processor 502-1 may include more than one router 510. Furthermore, the multitude of routers 510 may be in communication to enable data routing between various components inside or outside of the processor 502-1.

The shared cache 508 may store data (e.g., including instructions) that are utilized by one or more components of the processor 502-1, such as the cores 506. For example, the shared cache 508 may locally cache data stored in a memory 514 for faster access by components of the processor 502. In an embodiment, the cache 508 may include a mid-level cache (such as a level 2 (L2), a level 3 (L3), a level 4 (L4), or other levels of cache), a last level cache (LLC), and/or combinations thereof. Moreover, various components of the processor 502-1 may communicate with the shared cache 508 directly, through a bus (e.g., the bus 512), and/or a memory controller or hub. As shown in FIG. 5, in some embodiments, one or more of the cores 506 may include a level 1 (L1) cache 516-1 (generally referred to herein as “L1 cache 516”). In one embodiment, the controller 520 may include logic to implement the operations described above with reference to FIG. 3.

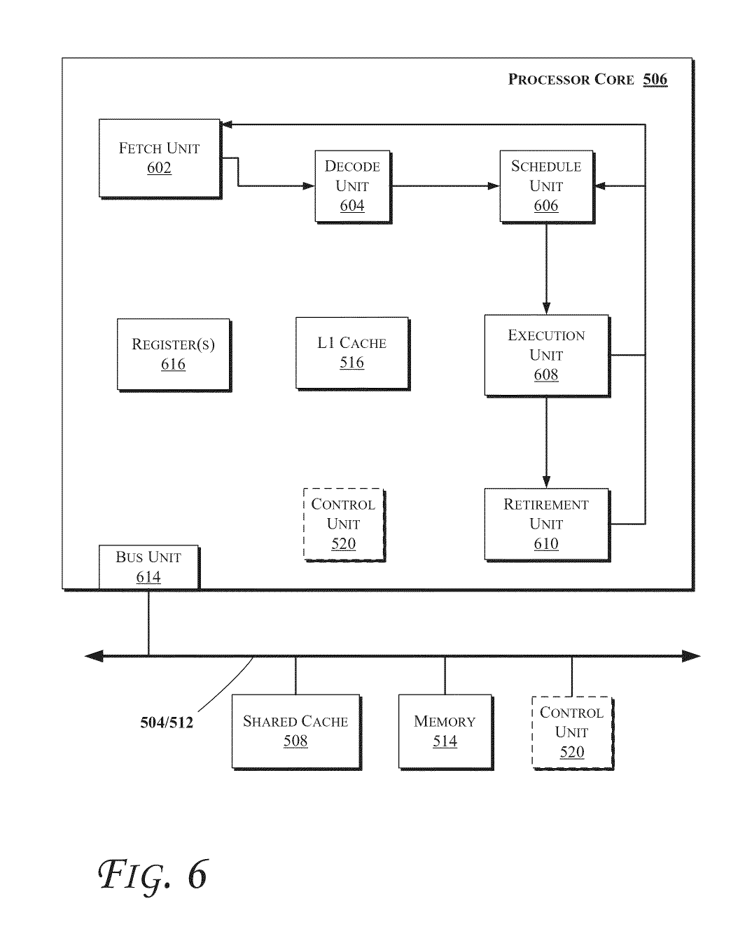

FIG. 6 illustrates a block diagram of portions of a processor core 506 and other components of a computing system, according to an embodiment of the invention. In one embodiment, the arrows shown in FIG. 6 illustrate the flow direction of instructions through the core 106. One or more processor cores (such as the processor core 106) may be implemented on a single integrated circuit chip (or die) such as discussed with reference to FIG. 5. Moreover, the chip may include one or more shared and/or private caches (e.g., cache 508 of FIG. 5), interconnections (e.g., interconnections 504 and/or 112 of FIG. 5), control units, memory controllers, or other components.

As illustrated in FIG. 6, the processor core 506 may include a fetch unit 602 to fetch instructions (including instructions with conditional branches) for execution by the core 606. The instructions may be fetched from any storage devices such as the memory 514. The core 506 may also include a decode unit 604 to decode the fetched instruction. For instance, the decode unit 604 may decode the fetched instruction into a plurality of uops (micro-operations).

Additionally, the core 606 may include a schedule unit 606. The schedule unit 606 may perform various operations associated with storing decoded instructions (e.g., received from the decode unit 604) until the instructions are ready for dispatch, e.g., until all source values of a decoded instruction become available. In one embodiment, the schedule unit 606 may schedule and/or issue (or dispatch) decoded instructions to an execution unit 608 for execution. The execution unit 608 may execute the dispatched instructions after they are decoded (e.g., by the decode unit 604) and dispatched (e.g., by the schedule unit 606). In an embodiment, the execution unit 608 may include more than one execution unit. The execution unit 608 may also perform various arithmetic operations such as addition, subtraction, multiplication, and/or division, and may include one or more an arithmetic logic units (ALUs). In an embodiment, a co-processor (not shown) may perform various arithmetic operations in conjunction with the execution unit 608.

Further, the execution unit 608 may execute instructions out-of-order. Hence, the processor core 506 may be an out-of-order processor core in one embodiment. The core 506 may also include a retirement unit 610. The retirement unit 610 may retire executed instructions after they are committed. In an embodiment, retirement of the executed instructions may result in processor state being committed from the execution of the instructions, physical registers used by the instructions being de-allocated, etc.

The core 106 may also include a bus unit 614 to enable communication between components of the processor core 506 and other components (such as the components discussed with reference to FIG. 6) via one or more buses (e.g., buses 604 and/or 612). The core 106 may also include one or more registers 616 to store data accessed by various components of the core 506 (such as values related to power consumption state settings).

Furthermore, even though FIG. 5 illustrates the control unit 520 to be coupled to the core 506 via interconnect 512, in various embodiments the control unit 520 may be located elsewhere such as inside the core 506, coupled to the core via bus 504, etc.

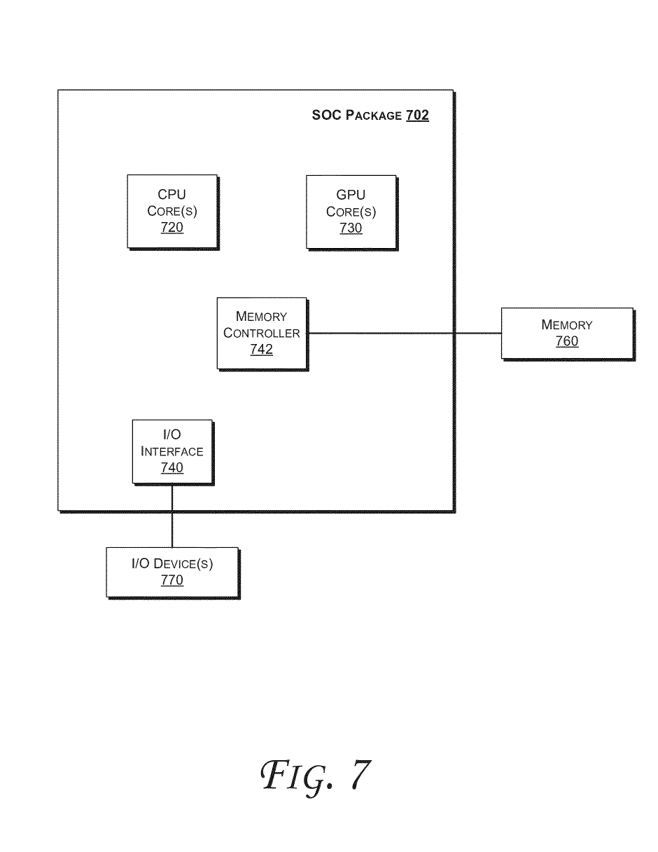

In some embodiments, one or more of the components discussed herein can be embodied as a System On Chip (SOC) device. FIG. 7 illustrates a block diagram of an SOC package in accordance with an embodiment. As illustrated in FIG. 7, SOC 702 includes one or more Central Processing Unit (CPU) cores 720, one or more Graphics Processor Unit (GPU) cores 730, an Input/Output (I/O) interface 740, and a memory controller 742. Various components of the SOC package 702 may be coupled to an interconnect or bus such as discussed herein with reference to the other figures. Also, the SOC package 702 may include more or less components, such as those discussed herein with reference to the other figures. Further, each component of the SOC package 720 may include one or more other components, e.g., as discussed with reference to the other figures herein. In one embodiment, SOC package 702 (and its components) is provided on one or more Integrated Circuit (IC) die, e.g., which are packaged into a single semiconductor device.

As illustrated in FIG. 7, SOC package 702 is coupled to a memory 760 (which may be similar to or the same as memory discussed herein with reference to the other figures) via the memory controller 742. In an embodiment, the memory 760 (or a portion of it) can be integrated on the SOC package 702.

The I/O interface 740 may be coupled to one or more I/O devices 770, e.g., via an interconnect and/or bus such as discussed herein with reference to other figures. I/O device(s) 770 may include one or more of a keyboard, a mouse, a touchpad, a display, an image/video capture device (such as a camera or camcorder/video recorder), a touch screen, a speaker, or the like.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and embodiments are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and embodiments are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one embodiment” or “some embodiments” means that a particular feature, structure, or characteristic described in connection with the embodiment is included in at least an implementation. The appearances of the phrase “in one embodiment” in various places in the specification may or may not be all referring to the same embodiment.

Although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A housing for an electronic device, comprising:
a first section to be rotatable about a first hinge pin extending along a first axis proximate a first edge;
a second section to be rotatable about a second hinge pin extending along a second axis substantially parallel to the first axis; and
at least one connecting arm to be coupled to the first hinge pin and the second hinge pin.

2. The housing of claim 1, wherein:
the first section comprises a first rolling surface extending along the first edge, the rolling surface extending radially about the first axis; and
the second section comprises a second rolling surface extending radially about the second axis.

3. The housing of claim 2, wherein:
the first rolling surface is disposed at a first distance from the first axis; and
the second rolling surface is disposed at a second distance from the second axis, wherein the first distance and the second distance are different.

4. The housing of claim 2, wherein:
the first rolling surface is disposed at a first distance from the first axis; and
the second rolling surface is disposed at a second distance from the second axis, wherein the first distance and the second distance are the same.

5. The housing of claim 2, wherein at least one of the first rolling surface or the second rolling surface comprises at least one of:
a friction-inducing pattern;
a friction-inducing coating; or
a friction-inducing material.

6. The housing of claim 2, wherein at least one of the first rolling surface or the second rolling surface comprises a gear assembly.

7. The housing of claim 2, wherein:
the first rolling surface and the second rolling surface are semicircular; and
the connecting arm is dimensioned to keep the first rolling surface and the second rolling surface in contact during rotation.

8. The apparatus of claim 1, wherein:
the first section comprises a keyboard assembly; and
the second section comprises a display assembly.

9. An electronic device, comprising:
at least one electronic component; and
a housing comprising:
a first section to be rotatable about a first hinge pin extending along a first axis extending proximate a first edge;
a second section to be rotatable about a second hinge pin extending along a second axis substantially parallel to the first axis; and
at least one connecting arm to be coupled to the first hinge pin and the second hinge pin.

10. The electronic device of claim 9, wherein:
the first section comprises a first rolling surface extending along the first edge, the rolling surface extending radially about the first axis; and
the second section comprises a second rolling surface extending radially about the second axis.

11. The electronic device of claim 10, wherein:
the first rolling surface is disposed at a first distance from the first axis; and
the second rolling surface is disposed at a second distance from the second axis, wherein the first distance and the second distance are different.

12. The electronic device of claim 10, wherein:
the first rolling surface is disposed at a first distance from the first axis; and
the second rolling surface is disposed at a second distance from the second axis, wherein the first distance and the second distance are the same.

13. The electronic device of claim 10, wherein at least one of the first rolling surface or the second rolling surface comprises at least one of:
a friction-inducing pattern;
a friction-inducing coating; or
a friction-inducing material.

14. The electronic device of claim 10, wherein at least one of the first rolling surface or the second rolling surface comprises a gear assembly.

15. The electronic device of claim 10, wherein:
the first rolling surface and the second rolling surface are semicircular; and
the connecting arm is dimensioned to keep the first rolling surface and the second rolling surface in contact during rotation.

16. The electronic device of claim 9, wherein:
the first section comprises a keyboard assembly; and
the second section comprises a display assembly.

17. A hinge assembly, comprising:
a first hinge pin extending along a first axis;
a first body rotatable about the first hinge pin and having a first rolling surface, a portion of which extends radially about the first axis;
a second hinge pin extending along a second axis substantially parallel to the first axis;
a second body rotatable about the second hinge pin and having a second rolling surface, a portion of which extends radially about the second axis; and
at least one connecting arm to be coupled to the first hinge pin and the second hinge pin and dimensioned such that the first rolling surface is to maintain contact with the second rolling surface during a rotation of the hinge assembly.

18. The hinge assembly of claim 17, wherein:
the first rolling surface is disposed at a first distance from the first axis; and
the second rolling surface is disposed at a second distance from the second axis, wherein the first distance and the second distance are different.

19. The hinge assembly of claim 17, wherein:
the first rolling surface is disposed at a first distance from the first axis; and
the second rolling surface is disposed at a second distance from the second axis, wherein the first distance and the second distance are the same.

20. The hinge assembly of claim 17, wherein at least one of the first rolling surface or the second rolling surface comprises at least one of:
a friction-inducing pattern;
a friction-inducing coating; or
a friction-inducing material.

21. The hinge assembly of claim 17, wherein at least one of the first rolling surface or the second rolling surface comprises a gear assembly.
